(19) United States
(12) Patent Application Publication
(10) Pub. No.: US 2012/0154436 A1
(43) Pub. Date: Jun. 21, 2012

(54) INFORMATION DISPLAY APPARATUS AND INFORMATION DISPLAY METHOD

(75) Inventor: Masahiro ITO, Hachioji-shi (JP)

(73) Assignee: CASIO COMPUTER CO., LTD, Tokyo (JP)

(21) Appl. No.: 13/329,764

(22) Filed: Dec. 19, 2011

(30) Foreign Application Priority Data
Dec. 21, 2010 (JP) 2010-283978

(51) Int. Cl. G09G 5/377; G06T 11/00

(52) U.S. Cl. 345/629; 345/467

(57) ABSTRACT

In an electronic apparatus, a processor is configured to allow the display screen to display a text specified by a user and included in the content stored in the memory, allow a user to specify a string as a keyword contained in the displayed text, create a note screen by receiving handwriting data entered, by a user via the touch panel, in a screen with the text displayed therein, store, in the memory, the created note screen data and the string specified as the keyword such that the note screen data and the string are associated with each other into note information, receive a search string input, by a user, and search the memory for note information including the search string as a keyword and allow the display screen to display a note screen corresponding to the searched-for note information.

### CROSS-REFERENCE TO RELATED APPLICATIONS

This application is based upon and claims the benefit of priority from prior Japanese Patent Application No. 2010-283978, filed Dec. 21, 2010, the entire contents of which are incorporated herein by reference.

### BACKGROUND OF THE INVENTION

1. Field of the Invention

The present invention relates to an information display apparatus and an information display method in which a text with information handwritten therein is displayed.

2. Description of the Related Art

Some conventional information display apparatuses called electronic dictionaries not only include a dictionary database and a word meaning display function but also contain a flash card function and a note function in order to improve learning effects.

As described in Jpn. Pat. Appln. KOKAI Publication No. 2010-211090, the flash card function allows a user to memorize a plurality of contents described on the front surfaces of flash cards in association with the same number of contents described on the back surfaces of the cards, for example, a plurality of words in association with the corresponding meanings. The flash card function further displays one of the surfaces of any card based on a user's operation, and subsequently displays the other surface.

The note function is as follows. With, for example, descriptive information on a headword in the dictionary displayed, if the user enters handwriting data in a display screen, the note function registers the image data in the form of a note screen, and subsequently displays the note screen.

However, the conventional note function forces the user to search for a previously registered note screen based on the registration number of the image data. Thus, disadvantageously, the conventional note function fails to allow registered note screens to be easily searched for.

### BRIEF SUMMARY OF THE INVENTION

Accordingly, it is an object of the present invention to provide an information display apparatus and an information display method, which allow registered note screens to be easily searched for.

According to one aspect of the present invention, there is provided an information display apparatus comprising: a display section; a touch panel provided on a display screen of the display section; a content storage section configured to store a content including texts; a display control section configured to allow the display section to display a text specified by a user and included in the content stored in the content storage section; a string specifying section configured to allow a user to specify a string as a keyword contained in the text displayed by the text display control section; a note screen creating section configured to create a note screen by receiving handwriting data entered, by a user via the touch panel, in a screen with the text displayed therein by the text display control section; a note information storage section configured to store the note screen data created by the note screen creating section and the string specified as the keyword such that the note screen data and the string are associated with each other into note information; a search string input section configured to receive a search string input by a user; and a note screen display control section configured to search the note information storage section for note information including the search string as a keyword and to allow the display section to display a note screen corresponding to the searched-for note information.

According to the present invention, it is possible to allow note screens to be easily searched for to improve the effects of learning, compared to the conventional case where note screens are searched for based on registration numbers for image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed cut hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view schematically showing an electronic dictionary to which the present invention is applied;

FIG. 2 is a block diagram showing the internal configuration of the electronic dictionary;

FIG. 3 is a conceptual drawing showing the data structure of a note database;

FIG. 4 is a flowchart illustrating an information display process;

FIG. 5 is a flowchart illustrating a note creating process;

FIG. 6 is a flowchart illustrating a note attaching process;

FIG. 7 is a flowchart illustrating a note browsing and editing process;

FIGS. 8A, 8B, and 8C are diagrams showing the contents of display by a display section;

FIGS. 9A, 9B, and 9C are diagrams showing the contents of a display provided by a display section;

FIGS. 10A, 10B, and 10C are diagrams showing the contents of a display provided by a display section;

FIGS. 11A, 118, and 11C are diagrams showing the contents (of a display provided by a display section;

FIGS. 12A, 12B, and 12C are diagrams showing the contents of a display provided by a display section;

FIGS. 13A, 138, and 13C are diagrams showing the contents of a display provided by a display section;

FIGS. 14A, 148, and 14C are diagrams showing the contents of a display provided by a display section; and

FIGS. 15A, 15B, and 15C are diagrams showing the contents of a display provided by a display section.

### DETAILED DESCRIPTION OF THE INVENTION

With reference to the drawings, embodiments will be described below in which an information display apparatus is applied to an electronic dictionary.

### [External Configuration]

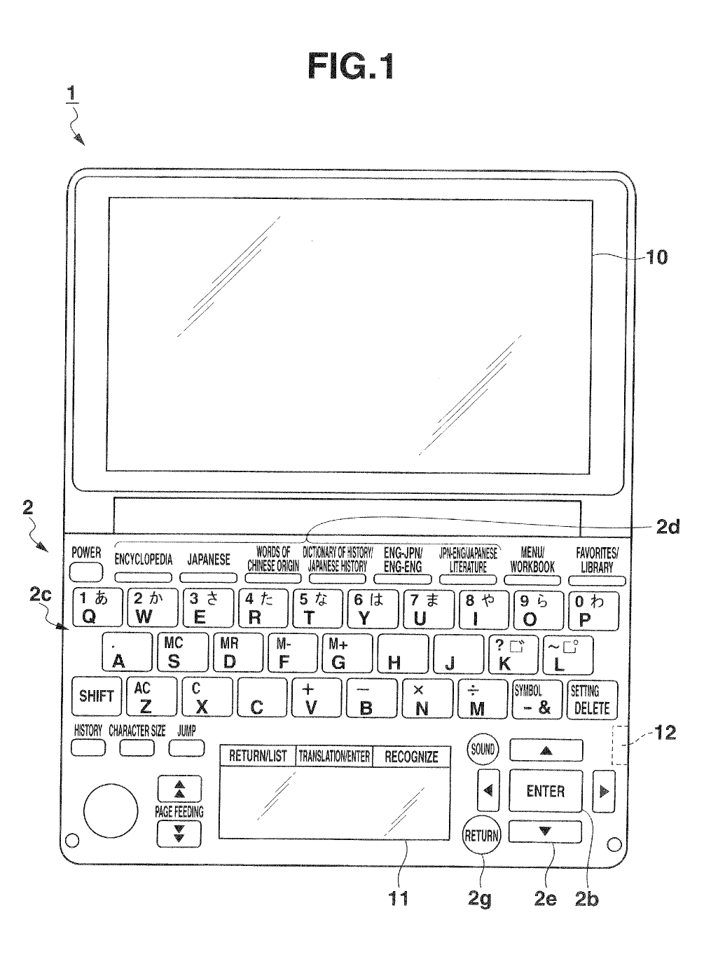

FIG. 1 is a plan view of an electronic dictionary. The electronic dictionary 1 includes a main display 10, a sub-display 11, a card slot 12, and a group of keys 2.

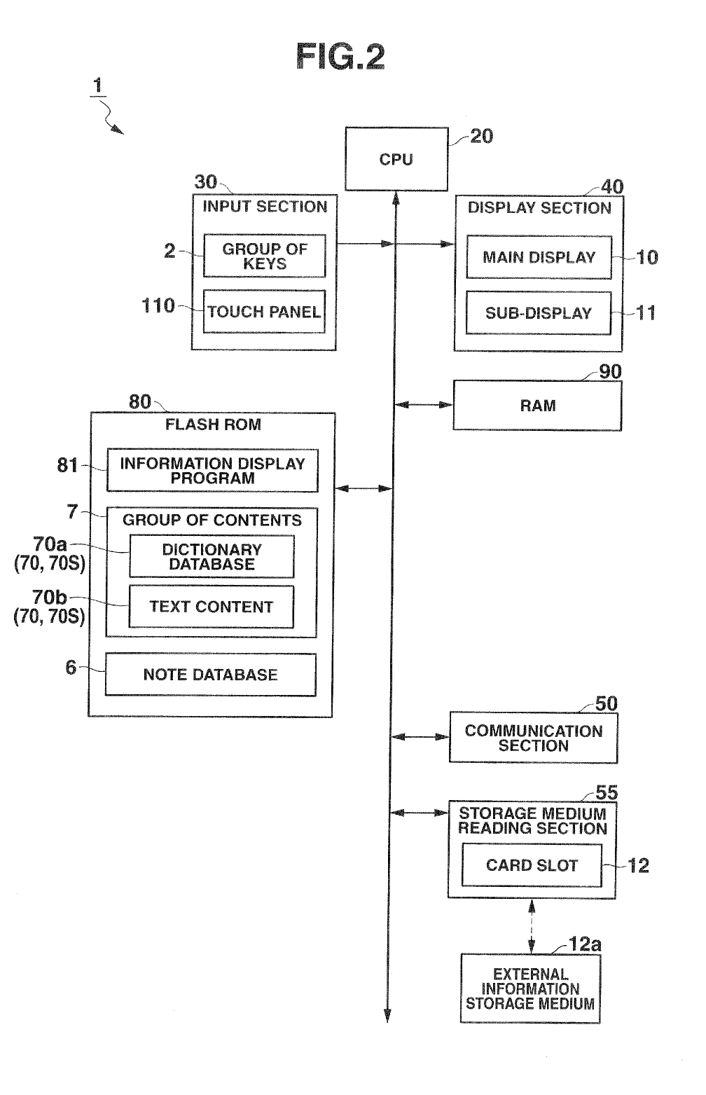

The main display 10 and the sub-display 11 are sections configured to display various data such as characters and codes which correspond to a user's operation of any of the group of keys 2. The main display 10 and the sub-display 11 include a liquid crystal display (LCD) or an electronic luminescence display (ELD). Each of the main display 10 and the sub-display 11 includes a touch panel 110 (FIG. 2) provided over a surface of the screen to accept operations such as handwriting inputs.

The card slot 12 is provided such that an external information storage medium 12a (FIG. 2) with various pieces of information stored therein can be installed in and removed from the card slot 12.

The group of keys 2 includes various keys configured to accept the user's operations. The group of keys 2 includes an enter key 2b, character keys 2c, a content selection key 2d, a cursor key 2e, and a return key 2g.

The enter key 2b is used to carry out searches and to determine headwords. The character keys 2c are used to allow a user to, for example, input characters and include an “A” key to a “Z” key. The content selection key 2d is used to select a dictionary database 70a described below and a text content 70b (FIG. 2).

The cursor key 2e is used to move a cursor by specifying an upward direction, a downward direction, a rightward direction, or a leftward direction. The return key 2g is used to, for example, return to a screen displayed last.

### [Internal Configuration]

The internal configuration of the electronic dictionary 1 will be described with reference to FIG. 2.

The electronic dictionary 1 includes a central processing unit (CPU) 20, an input section 30, a display section 40, a communication section 50, recording medium reading section 55, a flash read only memory (ROM) 80, and a random access memory (RAM) 90; all these sections are interconnected via a bus.

The display section 40 includes the above-described main display 10 and sub-display 11 to display various types of information based on display signals input by CPU 20.

The input section 30 includes the above-described group of keys 2 and the touch panel 110. The input section 30 outputs signals corresponding to a depressed key and a position on the touch panel 110 to CPU 20.

The communication section 50 is configured for short-distance communication via a wired/wireless local area network (LAN) or the like or configured to be able to connect to the Internet.

The recording medium reading section 55 includes the card slot 12 described above. The recording medium reading section 55 reads and records information from and on an external information storage medium 12a installed in the card slot 12.

The external information storage medium 12a is configured to store, for example, a content 70 downloaded via the communication section 50. The content 70 has a data structure similar to a content 70 in a flash ROM 80 described below and will thus not be described below.

CPU 20 performs processing based on predetermined programs in accordance with input instructions. CPU 20, for example, gives instructions to relevant functional sections and transfers data to control the electronic dictionary 1 in an integrated manner. Specifically, CPU 20 reads any of the various programs stored in the flash ROM 80 in accordance with, for example, an operation signal input via the input section 30. CPU 20 then performs processing in accordance with the program. CPU 20 thus saves the results of the processing to RAM 90 and appropriately outputs the results to the display section 40.

The flash ROM 80 is a memory configured to store programs and data required to implement various functions of the electronic dictionary 1. In the present embodiment, the flash ROM 80 is configured to store an information display program 81 according to the present invention, a group of contents 7, a note database 6, and the like.

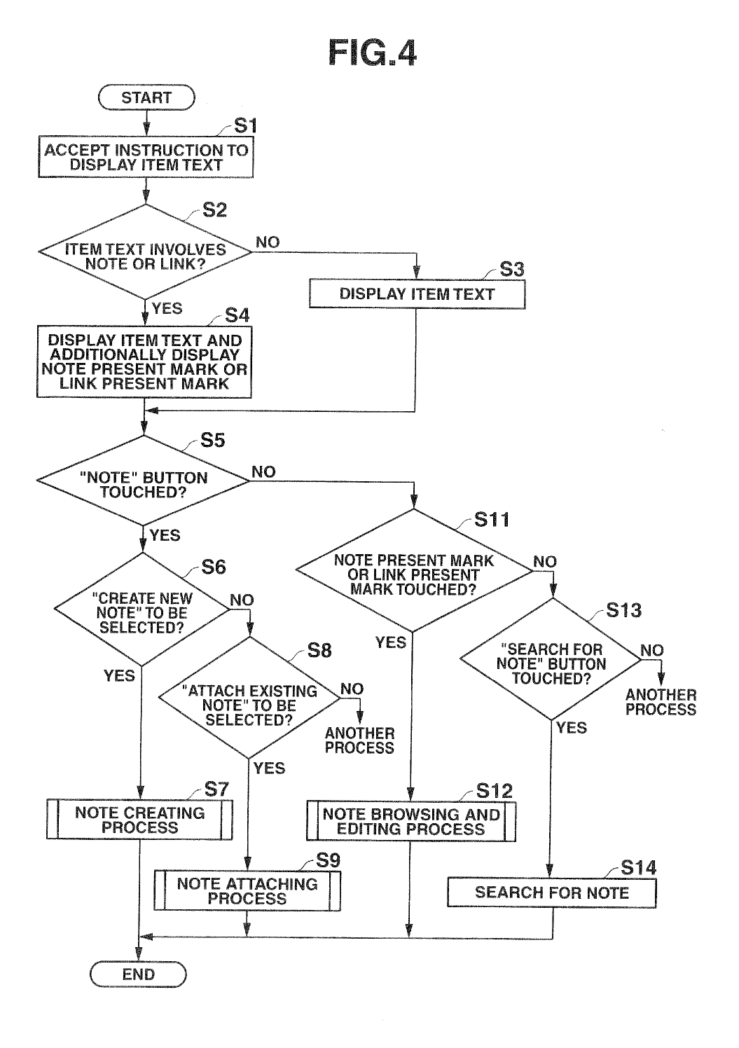

The information display program 81 allows CPU to carry out an information display process (FIG. 4) described below.

The group of contents 7 includes a plurality of databases 70a and a text content 70b.

The dictionary database 70a is configured to store at least one piece of dictionary information including a headword (item) and descriptive information (item text) on the headword. In the present embodiment, the dictionary database 70a includes a “dictionary of Japanese history,” an “encyclopedia,” and the like.

For example, novels such as 100 Japanese novels are stored in the text content 70b so that the titles of the novels are associated with chapter numbers (items) and texts (item texts) of the novels.

The note database 6 is configured to store note information 60 created by the user in the information display process (FIG. 4) described below. In the electronic dictionary, the note information 60 is used as follows. With item texts (descriptive information from the dictionary and texts of novels) displayed, the user specifies a string contained in the text displayed on the screen and then inputs characters or the like in handwriting. Then, the specified string and the handwriting data are recorded as note information 60 for the text screen.

The note information 60 includes a note number 61 which is indicative of the registration order of the note information 60 and which is associated with note screen data 62, a search keyword 63, registered icon data 64, and link origin position information 65.

The note screen data 62 is indicative of a text display screen to which the user has written data. The note screen data 62 includes handwriting image data 62a, pen color-used information 62b, registered position information 62c, and registered screen information 62d.

The handwriting image data 62a is data on a handwriting image input in handwriting via the touch panel 110.

The pen color-used information 62b is data indicative of a pen color used for handwriting input.

The registered position information 62c is data indicative of position information on an item text displayed during creation of a note screen. The data includes the name of the content 70, the item name of a displayed text portion (for the dictionary database 70a, a headword), and the leading row number of the displayed portion of the text of the item.

The registered screen information 62d is data indicative of display settings for the main display 10 during the creation of the note screen. Specifically, the registered screen information 62e includes a screen layout and a character size.

The search keyword 63 is a string used as a key to search for the note information 60. The user specifies the string in creating a note screen. If the string is formed of Chinese characters, a string indicative of reading of the Chinese characters is used.

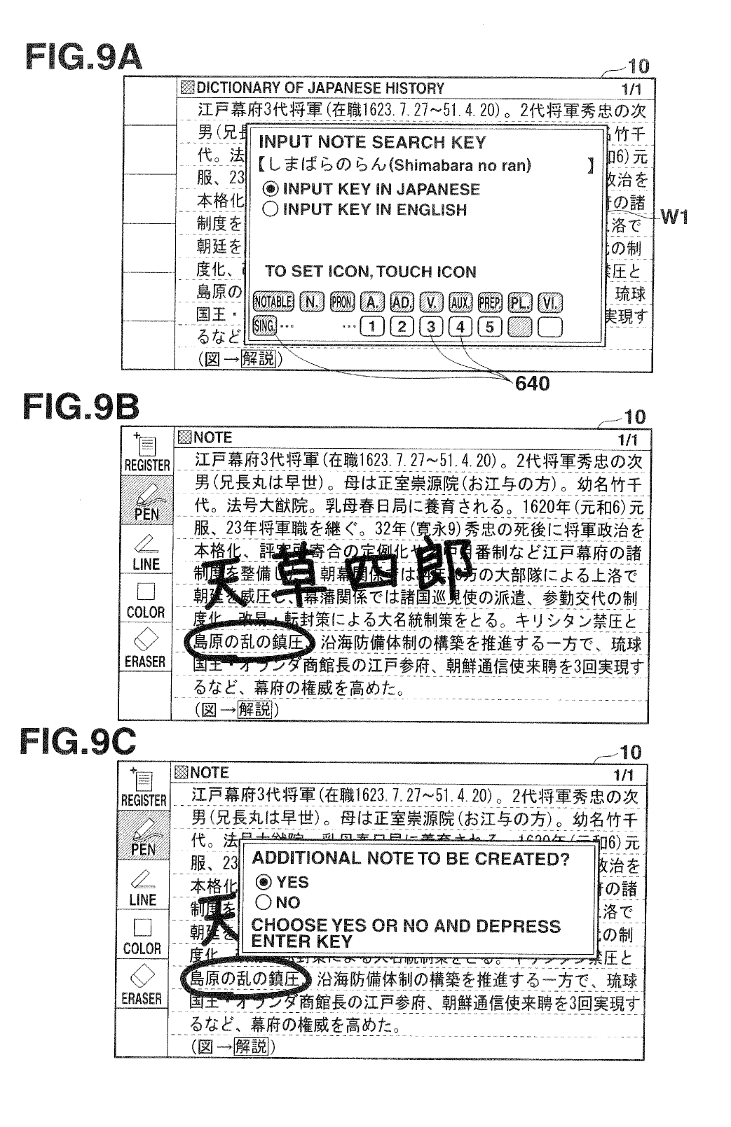

The registered icon data 64 is indicative of the type of an icon 640 (FIG. 9A) used as a key to search for the note information 60. The icon 640 is selected by the user.

The link origin position information 65 is data indicative of position information on an item text linked to the note screen. Specifically, the link origin position information 65 includes the name of the content 70 to which the note screen is linked, the item name of the text, and the leading row number of the displayed portion of the item text. The link origin position information 65 may include position information on a plurality of item texts.

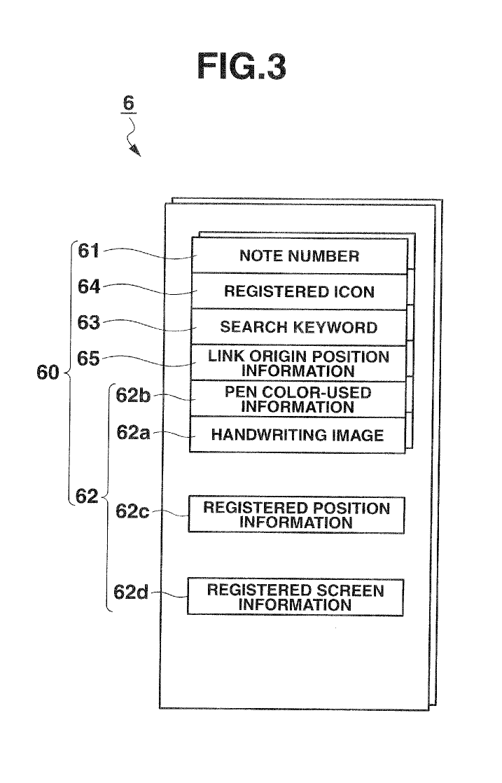

FIG. 3 schematically shows the note database 6 in which a plurality of pieces of the note information 60 with a plurality of handwriting images written in one item text screen are stored.

RAM 90 includes a memory area in which various programs executed by CPU 20 and data related to the execution of the programs are temporarily held.

### [Operation]

Subsequently, operation of the electronic dictionary 1 will be described with reference to the drawings.

<Information Display Process>

FIG. 4 is a flowchart illustrating a flow of an information display process in which CPU 20 reads and executes an information display program 81.

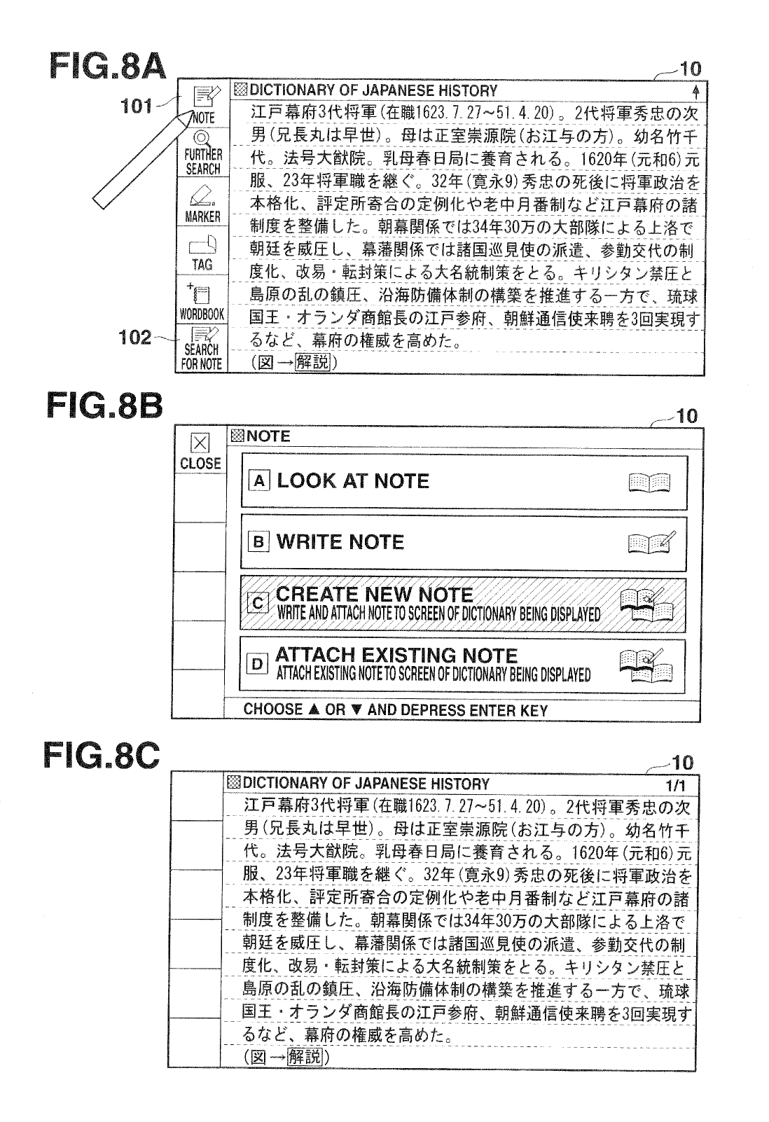

In an example of a display screen in FIG. 8A and subsequent figures, the contents of a dictionary of Japanese history are shown in Japanese. However, the contents of the screen display are not related to the present invention and are thus shown in Japanese without being translated into English.

In the information display process, first, CPU 20 accepts one specification for the content 70 and an instruction to display any item text in the content 70 (hereinafter referred to as the specified content 70S) (step S1). For example, in step S1, the user specifies one dictionary database 70a and inputs a headword to instruct CPU 20 to display the corresponding item text.

Then, CPU 20 determines whether the note database 6 contains note information 60 with registered position information 62c or link origin position information 65 that matches position information on the item text specified in the display instruction (step S2). That is, CPU 20 determines whether or not note information has been written in the item text or another note screen is linked to the item text.

In step S2, upon determining that no note information has been written to the item text and no note screen is linked to the item text (step S2; No), CPU 20 allows the main display 10 to display the item text (step S3).

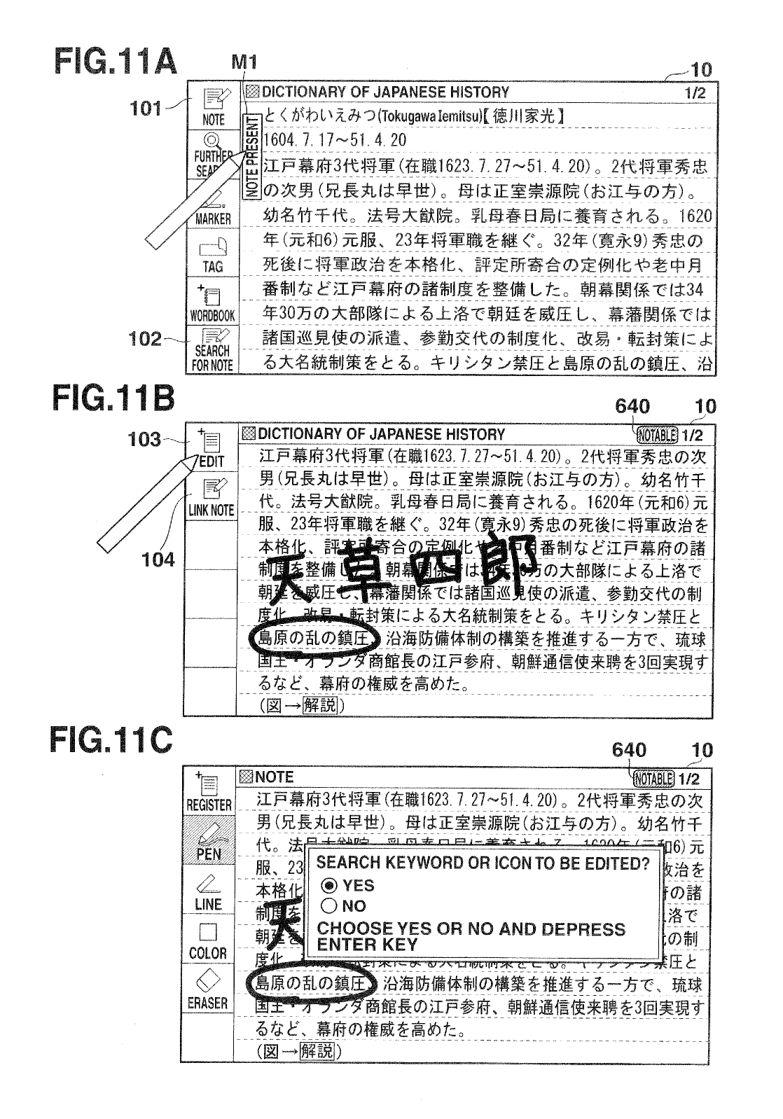

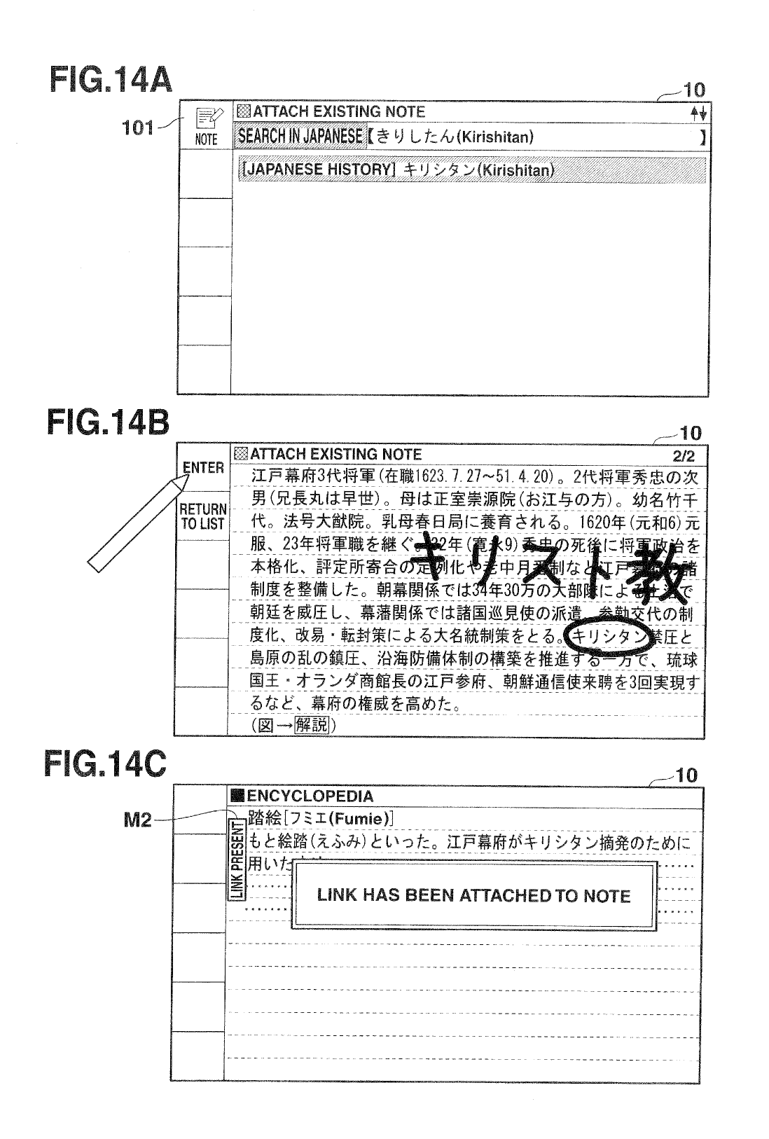

On the other hand, in step S2, upon determining that any note information has been written in the item text and another note screen is linked to the item text (step S2; Yes), CPU 20 allows the main display 10 to display not only the item text but also a note present mark M1 and/or a link present mark M2 (FIGS. 11A and 14C) (step S4).

The note present mark M1 indicates that a note screen is registered for the displayed text. The note present mark M1 is displayed if the position information on the text matches the registered position information 62c in the note information 60.

On the other hand, the link present mark M2 indicates that a note screen linked to the displayed text is registered. The link present mark M2 is displayed if the position information on the text matches the link origin position information 65 in the note information 60.

In steps S3 and S4, upon displaying the item text, CPU 20 displays a note button 101 and a note search button 102 at an end of the main display 10 (FIG. 8A).

The note button 101 is operated to create a new note screen and to link a created note screen to a currently displayed text. Furthermore, the note search button 102 is operated to search for and display a created note screen.

When an item text specified by the user is displayed, CPU 20 determines whether or not the note button 101 has been subjected to a touch operation (step S5). If the note button 101 has been subjected to a touch operation (step S5; Yes), CPU 20 displays a note operation menu (FIG. 8B), and determines whether or not an operation of creating a new note screen has been performed.

Upon determining that an operation of creating a new note screen has been performed (step S6; Yes), CPU 20 performs a note creating process (step S7).

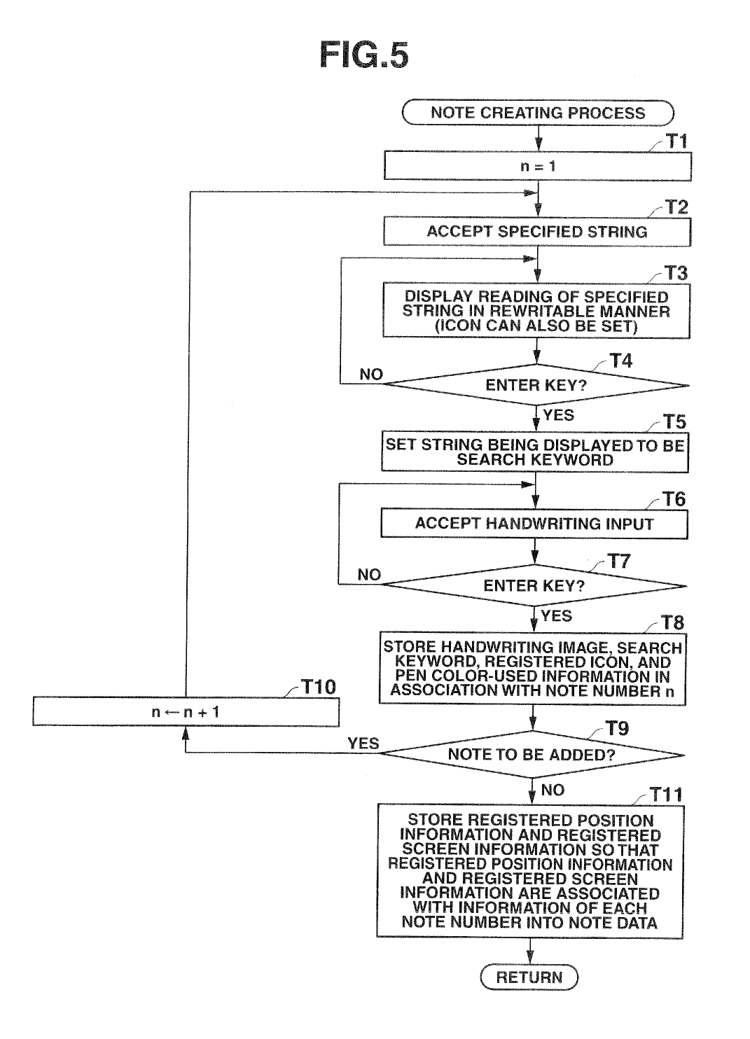

FIG. 5 illustrates a note creating process. In the note creating process, first, CPU 20 substitutes “1” into a count value “n” (step T1). CPU 20 then accepts an operation of specifying a string in a displayed text (step T2). The user specifies the string by touching the string itself with a pen or using the pen to draw a line enclosing the string (FIG. 8C).

Then, CPU 20 creates and displays a search key setting window W1 (FIG. 9A) on the main display 10 (step 13). The window W1 displays, as a search keyword, the specified string and if the specified string includes Chinese characters, the reading of the string. The user can rewrite the displayed string. Furthermore, CPU 20 displays, on the search key setting window W1, an icon 640 (FIG. 9A) to be used as a key to search for the note information 60, CPU 20 accepts the user's selection operation.

When the user operates the enter key 2b (step T4; Yes) after operating the search setting window W1, CPU 20 temporarily stores the string displayed in the search key setting window W1, in RAM 90 as a search keyword 63. CPU 20 then closes the search key setting window W1 (step T5). In step T5, if an icon 640 is previously selected in step T3 described above, CPU 20 temporarily stores the type of the icon 640 in RAM 90.

Then, CPU 20 accepts handwriting data entered in the display screen with text displayed therein. CPU 20 then temporarily stores an image of the entered handwriting data as handwriting image data 62a (step 16). This leads to creation of a note screen for the specified string. In step 16, CPU 20 accepts an operation of selecting a pen color used (the color of the handwriting image). If any color is selected, CPU 20 temporarily stores the color in RAM 90 in association with the input handwritten in that color as pen color-used information 62b.

When the user operates the enter key 2h (step T7; Yes) after the handwriting input, CPU 20 stores the handwriting image data 62a, the search keyword 63, the type of the icon 640, and the pen color-used information 62b, in the note database 6 in association with the note number 61 of “n” (step T8); the handwriting image data 62a, the search keyword 63, the type of the icon 640, and the pen color-used information 62b have all been temporarily stored in RAM 90.

Then, CPU 20 determines whether or not to perform an operation of additionally creating a note screen (step T9). If a note is added (step T9; Yes), CPU 20 adds “1” to the count value “n” (step T10). CPU 20 then shifts to step T2 to accept a specification for a string and a handwriting input. Thus, a plurality of note screens are created in the text display screen for the same portion of the specified content 705.

On the other hand, in step T9, upon determining that no additional note screen is to be created (step T9; No), CPU 20 stores the registered position information 62c and registered screen information 62d corresponding to the content currently displayed on the main display 10 so that the registered position information 62c and registered screen information 62d are associated with each piece of information of the note number 61 in the note database 6 to provide the note information 60 (step T11). CPU 20 then ends the note creating process.

On the other hand, when an operation of creating a new note is not performed in step S6 described above (step S6; No) but an operation of setting a link to the existing note for the displayed text is performed (step S8; Yes), CPU 20 shifts to a note attaching process (step S9).

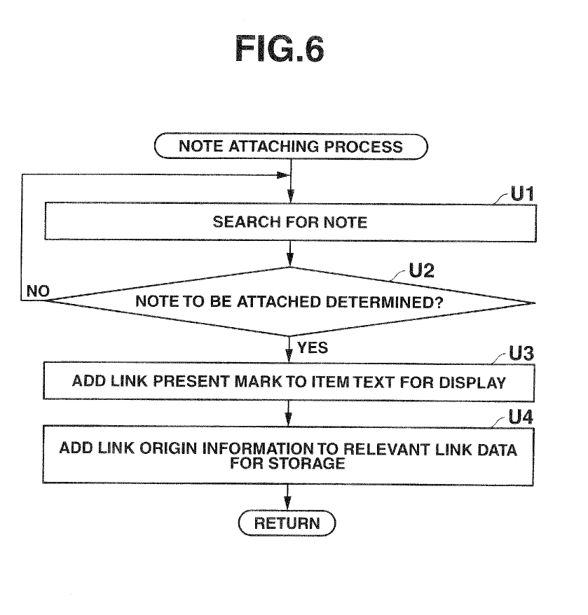

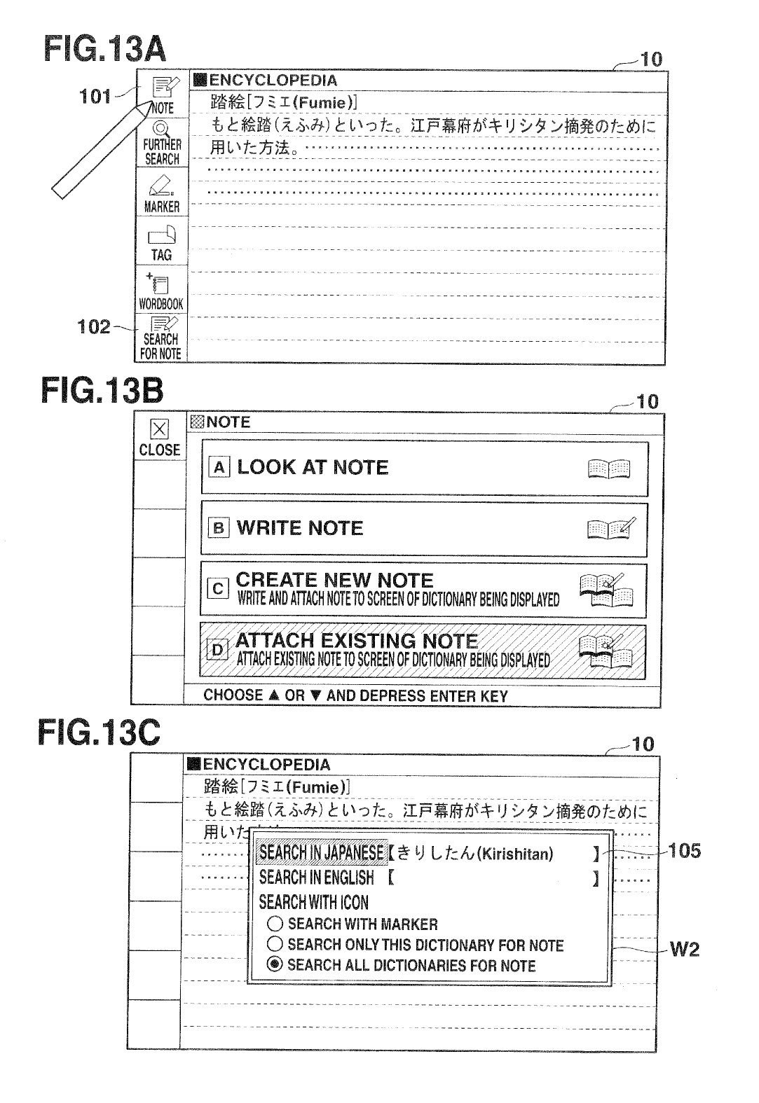

The note attaching process is illustrated in FIG. 6. In the note attaching process, first, CPU 20 searches for note information 60 based on the user's operation (step U1). At this time, CPU 20 displays a note search window W2 (FIG. 13C) containing an input column 105 for a string to be searched for. When the user inputs the string to be searched for, CPU 20 searches the note database 6 for note information 60 with a search keyword 63 that matches the string.

Depending on the user's operation on the note search window W2, the note information 60 on the specified content 70S may be exclusively searched for or the note information 60 on all the contents 70 may be searched for. Furthermore, the icon 640 may be specified to allow the note information 60 to be searched for.

When, after the search for the note information 60, an operation of determining the searched-for note screen to be a link destination is performed (step U2; Yes), CPU 20 closes the note search window W2. CPU 20 then allows the main display 10 to display the original text. CPU 20 further allows the main display 10 to display the link present mark M2 as the end thereof (step U3).

CPU 20 then stores position information on the displayed text in the note database 6 as link origin position information 65 on the searched-for note information 60 (step U4). Thus, the link origin position information 65, associating the displayed text with the selected note screen data 62, is stored in the note information 60.

Furthermore, upon determining that the note button 101 has not been operated in step S5 described above (step S5; No) but that the note present mark M1 or link present mark M2 displayed on the main display 10 has been subjected to a touch operation (step S11; Yes), CPU 20 performs a note browsing and editing process (step S12).

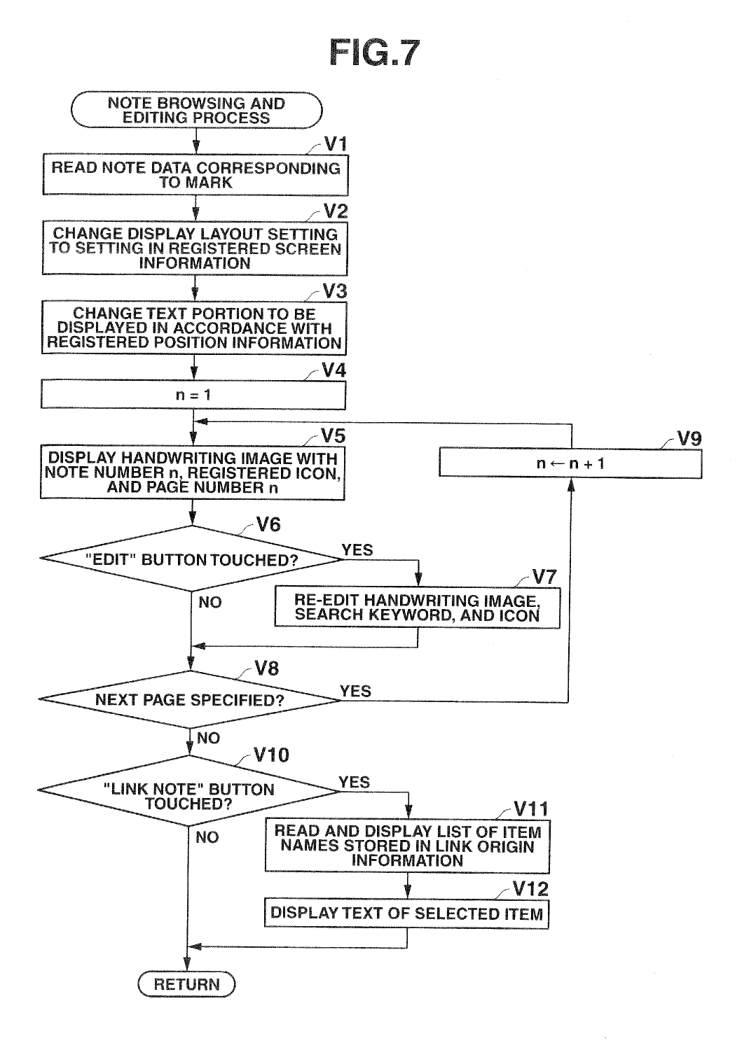

The note browsing and editing process is illustrated in FIG. 7. In the note browsing and editing process, first, CPU 20 reads the note information 60 (hereinafter referred to as the corresponding note information 60T) corresponding to the operated note present mark M1 or link present mark M2 (step 71). Specifically, if the note present mark M1 is operated, CPU 20 reads, as registered position information 62c, the note information including the text information on the text currently displayed on the main display 10. On the other hand, if the link present mark M2 is operated, CPU 20 reads, as corresponding note information 60T, the note information 60 including, as the link origin position information 65, the position information en the text currently displayed on the main display 10.

Then, CPU 20 changes the display settings for the main display 10 to those indicated by the registered screen information 62d in the corresponding note information 60T (step V2). CPU 20 then changes the text portion displayed on the main display 10 to the text indicated by the registered position information 62c in the corresponding note information 60T (step V3). Thus, the text displayed during creation of the note screen indicated by the corresponding note information 60T is displayed with display settings used during the creation of the note screen.

Then, CPU 20 substitutes “1” into the count value “n” (step V4). CPU 20 then reads the handwriting image data 62a with the note number 61 of “n=1” from the corresponding note information 60T read in step V1. CPU 20 displays the handwriting image so that the image is superimposed on the displayed text (step V5). Thus, if the note present mark M1 is touched, a note screen is displayed in which the user has performed a write operation on the original text. Furthermore, if the link present mark M2 is touched, a note screen is displayed which is attached to the original text.

At this time, CPU 20 reads the pen color-used information 62h with the note number 61 of “n” from the corresponding note information 60T. CPU 20 thus displays the handwriting image in a color indicated by the pen color-used information 62h. Furthermore, CPU 20 reads the registered icon data 64 and the note number 61 (count value “n”) from the corresponding note information 60T. CPU 20 then allows the main display 10 to display the icon 640 and page number indicated by the registered icon data 64, at the end thereof. Moreover, at this time, CPU 20 allows the main display 10 to display an edit button 103 and a note link button 104 at the end thereof (FIG. 11B). The edit button 103 is operated to give an instruction to edit the note screen. The note link button 104 is operated to give an instruction to display the item text registered as a link origin for the note screen.

Then, CPU 20 determines whether or not the edit button 103 has been touched (step V6). Upon determining that the edit button 103 has not been touched (step V6; No), CPU 20 shifts to step V8 described below.

Furthermore, in step V6, upon determining that the edit button 103 has been touched (step V6; Yes), CPU 20 accepts editing of the search keyword, the handwriting image, and the like and updates the note information 60, as is the case with step T3 to step T7 of the above-described note creating process (step V7).

Then, CPU 20 determines whether or not an instruction to display the next note screen teas been given (step V8). Upon determining that an instruction to display the next note screen has been given (step V8; Yes), CPU 20 adds “1” to the count value “n” (step VP). CPU 20 then shifts to step V5 described above. Thus, a plurality of note screens are displayed in order.

If an instruction to display the next note screen has not been given (step V8; No), CPU 20 determines whether or not the note link button 104 has been touched (step V10). Upon determining that the note link button 104 has not been touched (step V10; No), CPU 20 ends the note browsing and editing process.

Upon determining that the note link button 104 has been touched (step V10; Yes), CPU 20 reads the position information on the link origin text from the link origin position information 65 in the corresponding note information 60T on the currently displayed note screen. CPU 20 then allows the main display 10 to display a list of item names (step V11). When the user selects any of the item names, CPU 20 allows the main display 10 to display an item text indicated by the link origin position information 65 corresponding to the item name (step V12). After a text is displayed on the main display 10 in step V12, CPU 20 may shift to step S5 described above.

Furthermore, if the note present mark M1 or the link present mark M2 has not been subjected to a touch operation (step S11; No) but the note search button 102 has been operated (step Yes), CPU 20 performs a note search process as in the case of step U1 of the above-described note attaching process (step S14).

### [Example of Operation]

Now, the above-described information display process will be specifically described.

First, the user specifies the content 70 (dictionary database 70a) labeled as the “dictionary of Japanese history”, and performs a display instruction operation for the headword “ [symbol] (Tokugawa Iemitsu)” (step S1). Then, as shown in FIG. 8A, a searched-for item text is displayed on the main display 10 (step S3). At this time, the note button 101 and the note search button 102 are displayed at the end of the main display 10.

Then, when the user performs a touch operation on the note button 101 (step S5; Yes), the note operation menu is displayed as shown in FIG. 83. When the user performs an operation for creating a new note screen (step S6; Yes), CPU 20 shifts to a note creating process (FIG. 5), and “1” is substituted into the count value “n” (step T1).

Then, as shown in FIG. 8C, the user specifies the string “ [symbol] (shimabara no fan)” in the displayed text (step T2). Then, as shown in FIG. 9A, the search key setting window W1 is created on the main window 10, and the reading “ [symbol] (shimabara no ran)” of the specified string of Chinese characters is displayed as a search keyword (step 13). Furthermore, at this time, a list of icons 640 is displayed. The user can select, for example, the icon 640 labeled as “Notable”.

Then, when the user operates the enter key 2b (step T4; Yes), the string “ [symbol] (shimabara no ran)” displayed in the search key setting window W1 is temporarily stored in RAM 90 as a search keyword 63. The search key setting window W1 is then closed (step T5). Furthermore, the type of the icon 640 labeled as “Note” and selected by the user is temporarily stored in RAM 90.

Then, as shown in FIG. 9B, the user enters handwriting data in the screen with the text displayed thereon to create a note screen (step T6). An image of the entered handwriting data is temporarily stored in RAM 90 as handwriting image data 62a. At this time, the user can select a pen color, which is temporarily stored in RAM 90 as handwriting image data 62a.

Then, when the user operates the enter key 2b (step T7; Yes), the handwriting image data 62a, the search keyword 63, the type of the icon 640, and the pen color-used information 62b are stored in the note database 6 in association with the note number 61 of “1” (step T8); the handwriting image data 62a, the search keyword 63, the type of the icon 640, and the pen color-used information 62b have all been temporarily stored in RAM 90.

Then, as shown in FIG. 9C, when an operation window is displayed, and the user performs an operation for additionally creating a note screen (step T9; Yes), the count value “n” is then changed to “2” (step T10).

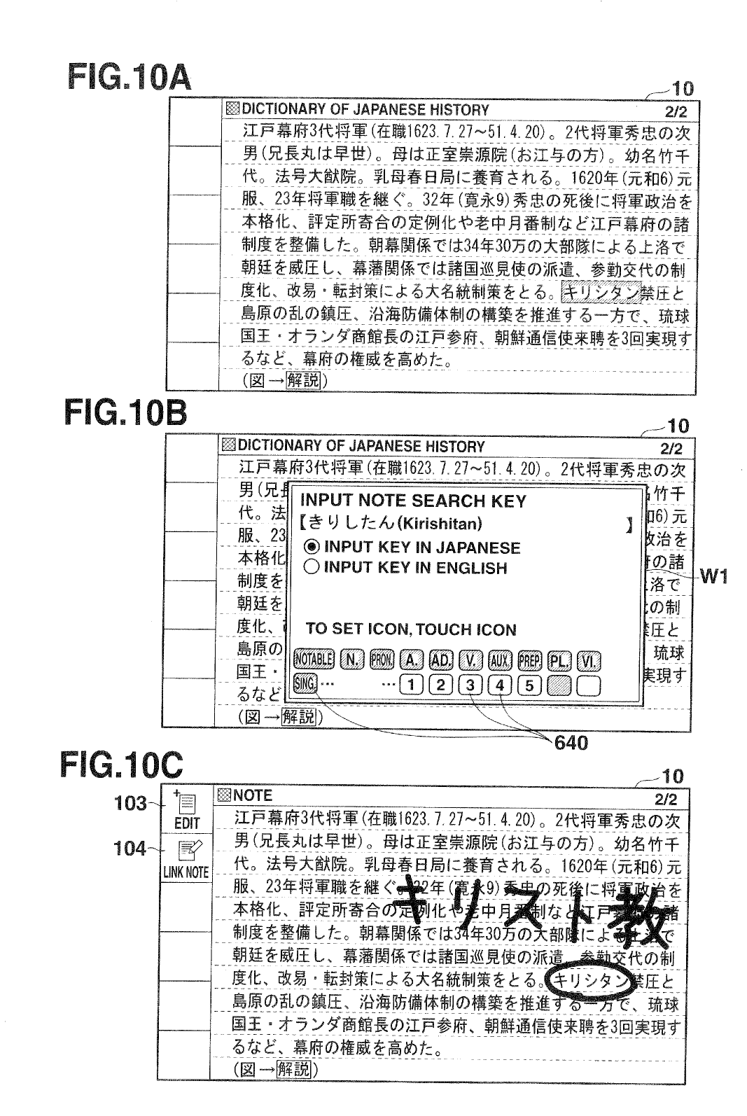

Then, as shown in FIG. 10A, the user performs an operation of specifying the string “ [symbol] (kirishitan)” in the displayed text (step T2). Then, as shown in FIG. 10B, the search key setting window W1 is created. The reading “ [symbol] (kirishitan)” of the specified string is displayed as a search keyword (step T3).

When the user operates the enter key 2b (step T4; Yes), the string “ [symbol] (kirishitan)” displayed in the search key setting window W1 is temporarily stored in RAM 90 as a search keyword 63. The search key setting window W1 is then closed (step T5).

Then, as shown in FIG. 10C, the user enters handwriting data in the text display screen (step T6). An image of the entered handwriting data is then temporarily stored in RAM 90 as handwriting image data 62a. If the user selects a pen color, the selected color is temporarily stored in RAM 90 as pen color-used information 62b.

Then, when the user operates the enter key 2b (step T7; Yes), the handwriting image data 62a, the search keyword 63, the type of the icon 640, and the pen color-used information 62h are then stored in the note database 6 in association with the note number 62 of “2” (step T8); the handwriting image data 62a, the search keyword 63, the type of the icon 640, and the pen color-used information 62b have all been temporarily stored in RAM 90.

When the user does not perform an operation for additionally adding a note screen (step T9; No), the registered position information 62c and registered screen information 62d corresponding to the content currently displayed on the main display 10 are stored so as to be associated with each piece of information of the note number 61 (“1” and “2”) in the note database 6, into the note information 60 (step T11).

After the note information is stored as described above, the user again specifies the content 70 (dictionary database 70a) labeled as the “dictionary of Japanese history” and performs a display instruction operation for the headword “ [symbol] (Tokugawa Iemitsu)” (step S1). Then, note information is searched for which includes the registered position information 62c matching the position information on the item text specified in the display instruction (step S2; Yes). As shown in FIG. 11A, the note present mark M1 is displayed together with the display of the item text (step S4). Furthermore, at this time, the note button 101 and the note search button 102 are displayed at the end of the main display 10. In the present example of operation, at this time, the display settings for the main display 10 have been changed so that a character size in units of points is larger than in the state shown in FIG. 8A to FIG. 10C described above.

Then, when the user performs a touch operation on the note present mark. M1 (step S11; Yes), the corresponding note information 60T corresponding to the note present mark M1 is read (step V1). Specifically, as the corresponding note information 60T, the pieces of note information 60 (the note information for which the note numbers 61 “1” and “2” have been registered by the above-described operation) are read which include, as the registered position information 62c, the position information on the text currently displayed on the main display 10.

Then, as shown in FIG. 11B, the display settings for the main display 10 are changed to those indicated by the registered screen information 62d in the corresponding note information 60T (step V2). The text displayed on the main display 10 is then changed to that indicated by the registered position information 62c in the corresponding note information 60T (step V3). Thus, the text portion displayed during the creation of the note screen indicated by the corresponding note information 601 is displayed with the display settings used during the creation of the note screen.

Then, “1” is substituted into the count value “n” (step V4). The handwriting image data 62a with the note number 61 of “1” is then read from the corresponding note information 60T. The read handwriting image is superimposed on the displayed text portion (step V5). The note number 61 (count value “1”; see the upper right portion of FIG. 11B) for the note screen and the icon 640 are also displayed. Furthermore, at this time, the edit button 103 and the note link button 104 are displayed at the end of the main display 10.

When the user performs a touch operation on the edit button 103 (step V6; Yes), an edit operation window is displayed as shown in FIG. 11C. The edit operation window shows options required to determine whether or not to edit the search keyword and the icon. At this time, when the option to avoid the editing of the search keyword and the icon is selected, only the handwriting image can be edited. When the option to edit the search keyword and the icon is selected, the search keyword, the icon, and the handwriting image can be edited.

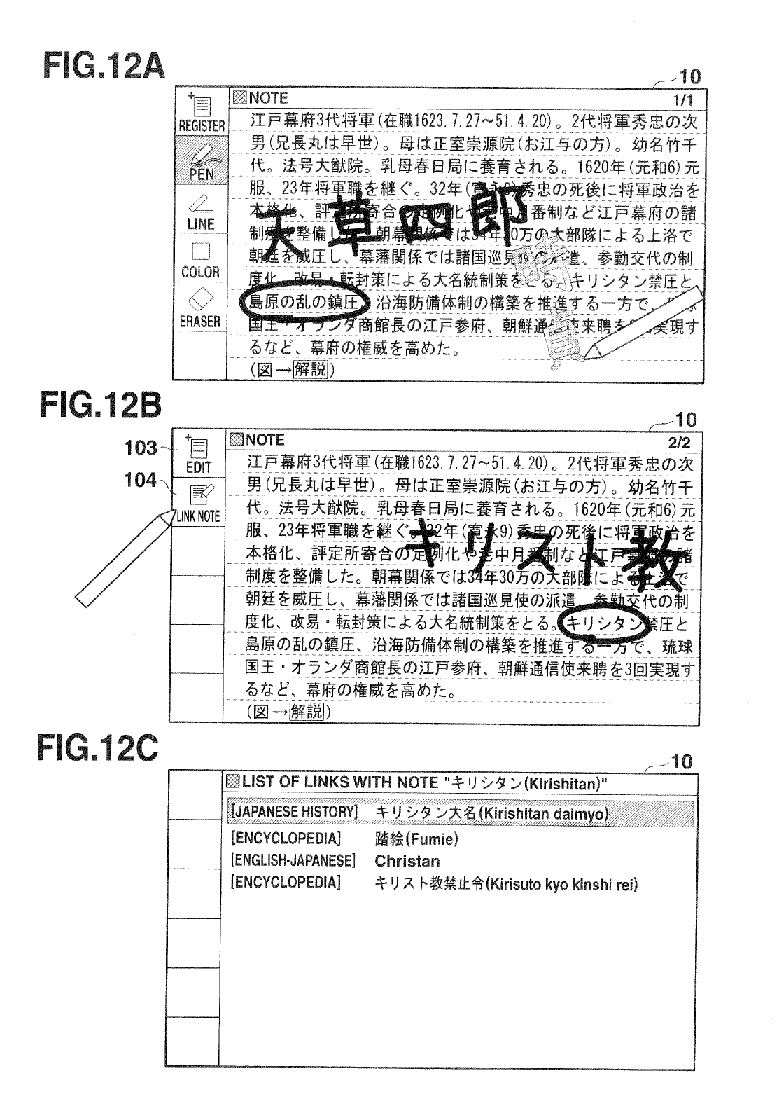

When the user chooses the option to avoid the editing of the search keyword and the icon and additionally edits the handwriting image as shown in FIG. 12A, the note information 60 is updated (step V7). FIG. 12A shows that new handwriting data is being additionally entered using a different pen color.

Then, when the user gives an instruction to display the next note screen (step V8; Yes), the count value “n” is changed to “2” (step V9). The handwriting image data 62a with the note number 61 of “2” is then read from the corresponding note information 60T. The read handwriting image is superimposed on the displayed text portion as shown in FIG. 12B (step V5). Furthermore, at this time, the note number 61 (the count value “2”; see the upper right portion of FIG. 12B) of the currently displayed note screen, the edit button 103, and the note link button 104 are displayed at the end of the main display 10.

When the user touches the note link button 104 (step V10; Yes), the item names of the item texts registered as link origins are read and displayed, in a list form, on the main display 10 based on the link origin position information 65 in the corresponding note information 60T (the note information with the note number 61 “2”) corresponding to the note screen being displayed, as shown in FIG. 120. In the present example of operation, the link origin position information 65 includes position information on the item text of the item “ [symbol] (kirishitan daimyo)” in the dictionary database 70a labeled as the “dictionary of Japanese history” and position information on the item text of the item “ [symbol] (fumie)” in the dictionary database 70a labeled as the “encyclopedia”.

Then, when the user selects the item name “ [symbol] (fumie)” in the dictionary database 70a labeled as the “encyclopedia”, the text portion indicated by the link origin position information 65 corresponding to the item name is displayed on the main display 10, as shown in FIG. 13A (step V12). In the present embodiment, the processing shifts from step V12 to step S5.

When the user performs a touch operation on the note button 101 (step S5; Yes), the note operation menu is displayed as shown in FIG. 133. Here, when the user performs an operation of setting a link to an existing note (step S8; Yes), the note information 60 is searched for based on the user's operation as shown in FIG. 130 (step U1). During the search, the note search window W2 is created on the main display 10. Then, when the user inputs the search string “ [symbol] (kirishitan)” to the input column 105, the following occurs as shown in FIG. 11A. The note information 60 including the search keyword 63 corresponding to the search string is retrieved from the note database 6. A list of the specified strings in the detected note information 60 is displayed on the main display 10.

Then, when the user selects “ [symbol] (kirishitan)” in the “dictionary of Japanese history”, the corresponding note screen is displayed as shown in FIG. 14B. When the user performs an operation of determining the note screen to be a link origin (step P2; Yes), a message indicating that the note screen has been linked is displayed on the main display 10, with the link present mark M2 displayed at the end of the main display 10, as shown in FIG. 14C (step U3).

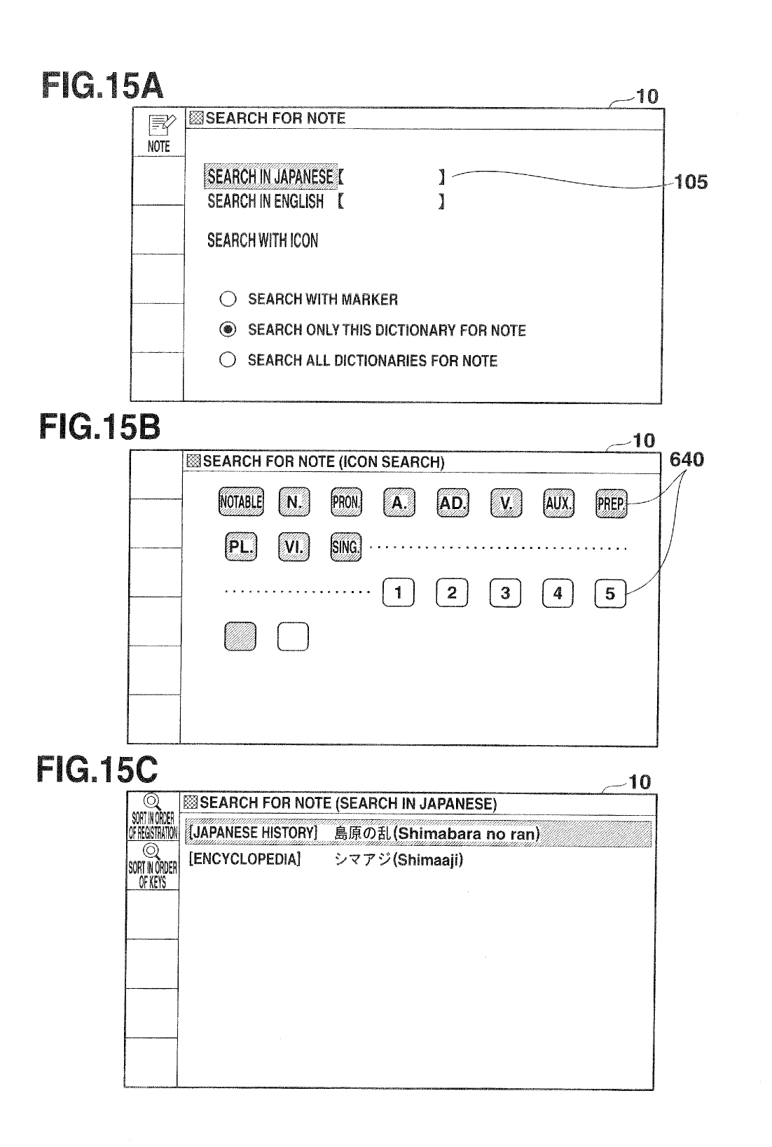

Furthermore, in the state shown in FIG. 11A and other figures described above, when the user operates the note search button 102 (step S13, Yes), the note information 60 is searched for based on the user's operation (step q14). In this case, as shown in FIG. 15A, at this time, the note search window W2 is created in front of the main display 10. Furthermore, the search string input column 105 is displayed. Moreover, the following are displayed: an option to search for only the note information 60 on the specified content 703 and an option to search for the note information 60 on all the contents 70. In FIG. 15A, the text otherwise displayed in the background of the note search window W2 is omitted.

When an operation for a search with the icon 640 is performed, a list of the icons 640 for the registered icon data 64 included in the note information 60 is displayed as shown in FIG. 15B. The note information 60 corresponding to the icon 640 selected by the user is searched for.

On the other hand, in the state shown in FIG. 15A, when the user selects the option to search for the note information 60 on all the contents 70 and inputs the search string “ [symbol] (shima)” to the input column 105, the note information 60 on the search keyword 63 corresponding to the search string (prefix search) is retrieved from the note database 6. A list of the specified strings in the registered position information 62c in each detected piece of note information 60 is displayed on the main display 10.

The embodiments to which the present invention is applicable are not limited to those described above and may be varied without departing from the spirit of the present invention.

For example, the electronic dictionary 1 has been described as the information display apparatus according to the present invention. However, the apparatus to which the present invention is applicable is not limited to such a product. The present invention is applicable to electronic equipment in general such as a cellular phone, a personal computer, a personal digital assistant (FDA), and a game machine. Furthermore, the information display program 81 according to the present invention may be stored in an external information storage medium 12a that can be installed in and removed from the electronic dictionary 1.

Additionally, in the above description, the note screen data 62 includes the handwriting image data 62a, the pen color-used information 62b, the registered position information 62c, and the registered screen information 62d. However, the note screen data 62 may include image data on a screen shot taken during the creation of a note screen.

In addition, in the above-described example of operation, a link is set from the text to the note screen in the dictionary database 70a. However, a link may be set from any text portion of the text content 70b.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information display apparatus comprising:
a display section;
a touch panel provided on a display screen of the lay section;
content storage section configured to store content including texts;
a display control section configured to allow the display section to display a text specified by a user and included in the content stored in the content storage section;
a string specifying section configured to allow a user to specify a string as a keyword contained in the text displayed by the text display control section;
a note screen creating section configured to create a note screen by receiving handwriting data entered, by a user via the touch panel, in a screen with the text displayed therein by the text display control section;
a note information storage section configured to store the note screen data created by the note screen creating section and the string specified as the keyword such that the note screen data and the string are associated with each other into note information;
a search string input section configured to receive a search string input by a user; and
a note screen display control section configured to search the note information storage section for note information including the search string as a keyword and to allow the display section to display a note screen corresponding to the searched-for note information.

2. The information display apparatus according to claim 1, wherein
the note information storage section stores display position information on the text displayed during creation of the note screen such that the display position information is included in the note information,
the text display control section includes a first information section configured to inform a user that a note screen has been created when a text specified by a user is displayed and if any display position information on the text is included in the note information as position information on the text, and
the note screen display control section allows the display section to display a note screen corresponding to a user's operation performed in response to the information from the first information section.

3. The information display apparatus according to claim 2, wherein
the note screen data includes image data on a handwriting image input in handwriting by a user via the touch panel and display setting information on the display screen displayed during the creation of the note screen, and
the note screen display control section allows the display section to display a text portion displayed during the creation of the note screen with a display setting used during the creation of the note screen, based on the display position information on the text and the display setting information, and to display the handwriting image such that the handwriting image is superimposed on the display content provided by the display section.

4. The information display apparatus according to claim 3, further comprising a link generating section configured to read and link note information stored in the note information storage section to a text specified by a user while the text display section is displaying the text specified by a user, wherein
the text display control section includes a second information section configured to inform a user that linked note screen has been created when the text specified by a user is displayed and if any note information is linked to the text, and
the note screen display control section allows the display section to display a note screen corresponding to a user's operation performed in response to the information from the second information section. claim 4, wherein
the content is a dictionary content including a headword and descriptive information on the headword which are stored in association with each other, and
the note screen creating section receives handwriting data entered, by a user via the touch panel, in a screen with a text of the descriptive information from the dictionary displayed therein.

6. The information display apparatus according to claim 1, further comprising an edit section configured to edit the note screen corresponding to the note information stored in the note information storage section.

7. The information display apparatus according to claim 1, wherein the note screen display control section includes a search range setting section configured to set a search range used when the note information storage section is searched for note information.

8. An information display method for use in an electronic apparatus including a display screen with a touch panel and a memory configured to store a content including texts, the method comprising:
performing a text display process of allowing the display screen to display a text specified by a user and included in the content stored in the memory;
performing a string specifying process of allowing a user to specify a string as a keyword contained in the text displayed in the text display process;
performing a note screen creating process of creating a note screen by receiving handwriting data entered, by a user via the touch panel, in a screen with the text displayed therein in the text display process;
performing a note information storing process of storing, in the memory, the note screen data created in the note screen creating process and the string specified as the keyword such that the note screen data and the string are associated with each other into note information;
performing a search string input process of receiving a sear string input by a user; and
performing a note screen display process of searching the memory for note information including the search string as a keyword and allowing the display screen to display a note screen corresponding to the searched-for note information.

9. The information display method according to claim 8, wherein
performing the note information storing process includes storing display position information on the text displayed during creation of the note screen such that the display position information is included in the note information,
performing the text display process includes performing a first informing process of informing a user that a note screen has been created when a text specified by a user is displayed and if any display position information on the text is included in the note information as position information on the text, and
performing the note screen display process includes allowing the display section to display a note screen corresponding to a user's operation performed in response to the information in the first informing process.

10. The information display method according to claim 9, wherein
performing the note information storing process includes storing, in the memory, image data on a handwriting image input in handwriting by a user via the touch panel and display setting information on the display screen displayed during the creation of the note screen, and
performing the note screen display process includes allowing the display screen to display a text portion displayed during the creation of the note screen with a display setting used during the creation of the note screen, based on the display position information on the text and the display setting information, and to display the handwriting image such that the handwriting image is superimposed on the display content provided by the display screen.

11. The information display method according to claim 10, further comprising performing a link generating process of reading and linking note information stored in the memory to a text specified by a user while the text specified by a user is being displayed in the text display process, wherein
performing the text display process includes performing a second informing process of informing a user that a linked note screen has been created when the text specified by a user is displayed and if any note information is linked to the text, and
performing the note screen display process includes allowing the display screen to display a note screen corresponding to a user's operation performed in response to the information in the second informing process.

12. The information display method according to claim 11, wherein
the content is a dictionary content including a headword and descriptive information on the headword which are stored in association with each other, and
performing the note screen creating process includes receiving handwriting data entered, by a user via the touch panel, in a screen with a text of the descriptive information from the dictionary displayed therein.

13. The information display method according to claim 8, further comprising performing an editing process of editing the note screen corresponding to the note information stored in the memory in the note information storing process.

14. The information display method according to claim 8, wherein performing the note screen display process includes performing a search range setting process of setting a search range used when the memory is searched for note information.

15. An electronic apparatus comprising:
a display screen with a touch panel;
a memory configured to store a content including texts; and
a processor configured to:
allow the display screen to display a text specified by a user and included in the content stored in the memory,
allow a user to specify a string as a keyword contained in the displayed text,
create a note screen by receiving handwriting data entered, by a user via the touch panel, in a screen with the text displayed therein,
store, in the memory, the created note screen data and the string specified as the keyword such that the note screen data and the string are associated with each other into note information,
receive a search string input by a user, and
search the memory for note information including the search string as a keyword and allow the display screen to display a note screen corresponding to the searched-for note information.

16. The electronic apparatus according to claim 15, wherein
the processor stores display position information on the text displayed during creation of the note screen such that the display position information is included in the note information when the processor stores the note information in the memory,
the processor informs a user that a note screen has been created when the processor displays the text and if any display position information on the text is included in the note information as position information on the text, and
the processor allows the display screen to display a note screen corresponding to a user's operation performed in response to the information indicative of presence of a note.

17. The electronic apparatus according to claim 16, wherein
when the processor stores the note information in the memory, the processor stores, in the memory, image data on a handwriting image input in handwriting by a user via the touch panel and display setting information on the display screen displayed during the creation of the note screen, and
when the processor displays the note screen, the processor allows the display screen to display a text portion displayed during the creation of the note screen with a display setting used during the creation of the note screen, based on the display position information on the text and the display setting information, and to display the handwriting image such that the handwriting image is superimposed on the display content provided by the display screen.

18. The electronic apparatus according to claim 17, wherein
the processor reads and links note information stored in the memory to a text while the text is being displayed,
the processor informs a user that a linked note screen has been created when the processor displays the text specified by a user and if any note information is linked to the text, and
the processor allows the display screen to display a note screen corresponding to a user's operation performed in response to the information indicative of presence of a link.

19. The electronic apparatus according to claim 15, wherein the processor performs a process of editing the note screen corresponding to the note information stored in the memory.

20. The electronic apparatus according to claim 15, wherein the processor performs a process of setting a search range used when the memory is searched for note information.
